(19) United States
(12) Patent Application Publication
(10) Pub. No.: US 2009/0195829 A1
(43) Pub. Date: Aug. 6, 2009

(54) PRINTING SYSTEM, INFORMATION PROCESSING APPARATUS, DATA PROCESSING METHOD, AND STORAGE MEDIUM

(75) Inventor: Satoshi Tanaka, Kawasaki-shi (JP)

Correspondence Address: CANON U.S.A. INC. INTELLECTUAL PROPERTY DIVISION, 15975 ALTON PARKWAY, IRVINE, CA, 92618-3731, US

(73) Assignee: CANON KABUSHIKI KAISHA, Tokyo (JP)

(21) Appl. No.: 12/365,087

(22) Filed: Feb. 3, 2009

(30) Foreign Application Priority Data
Feb. 4, 2008 (JP) 2008-024211

(51) Int. Cl. G06F 3/12

(52) U.S. Cl. 358/1.15

(57) ABSTRACT

A dummy driver in a terminal server determines whether an interface that cannot be used by a printer driver which is directly accessed by an application needs to be used in a print setting set by the application. If the dummy driver determines that the interface which cannot be used by the printer driver needs to be used, the dummy driver generates a print setting using a print setting that does not need to use a unique interface. Then, validation of the print setting is performed by a printer driver in a client and the print setting is replaced with a print setting of on a common interface. Then, the printing process is executed by the print setting generated by the printer driver in the client.

### BACKGROUND OF THE INVENTION

1. Field of the Invention

The present invention relates to a printing system, more specifically, performing a printing process using a server and a client.

2. Description of the Related Art

In performing printing using a printing system including a client computer and a printer, a user installs a printing application and a printer driver which cause the printer to print in the client computer. Then, the user uses the application to give a printing instruction and set a print setting using a common interface determined by the printer driver and an operating system (OS).

However, in a case where a close cooperative operation between the application and a device is necessary, such as when a device-specific expanded function is used from the application, there was a problem that the user could not use the device-specific expanded function since a setting method has not been defined in the common interface.

The above-described expanded function is, for example, a function for setting a printer-specific function such as stapling or acquiring printer configuration information. In order to solve the above-described problem, U.S. Pat. No. 6,847,466 discusses a method in which a unique interface, different from the common interface, is generated for the printer driver so that the application can use the unique interface.

Conventionally, in a printing system including a terminal server and a terminal client, a following method has been taken when a user prints a document.

First, the user connects the terminal client to the terminal server. Next, the user starts the application in the terminal server, opens a document, and selects printing from an application menu. According to this operation, the printer driver installed in the terminal server is activated. Then, the user sets a printing attribute and instructs printing using the printer driver. The printer driver in the terminal server generates an actual printing job and sends the printing job to the printer.

In the above-described printing system, a close cooperative operation between the application and the printer driver which cannot be realized by a common interface can be realized by generating a unique interface for the printer driver.

In addition to the above-described printing system including the terminal server, a different type of printing system including a terminal server and a terminal client has been publicly used. According to the printing system, an application and a printer driver are installed in the terminal server, and additionally another printer driver is installed in the terminal client to connect a printer. According to the printing system, when the user connects the terminal client to the terminal server and gives a printing instruction from the application installed in the terminal server, printing will be performed as follows.

First, the application in the terminal server sends a print job to the printer driver in the terminal server. Next, the printer of the terminal server basically sends the print job sent from the application to the terminal client and a print job receiving unit in the terminal client receives the print job. The print job receiving unit sends the print job to the printer driver in the terminal client. Subsequently, the printer driver in the terminal client converts the print job into rendering data which is interpretable by the printer, if necessary, and sends the print job or the rendering data to the printer. The printer performs printing using the print job or the rendering data.

However, according to this new type of printing system, since the printer driver which is actually connected to the printer is installed in the terminal client, the printer driver is not accessible from the application.

The printer driver which is installed in the terminal server and accessible from the application has a function dedicated to sending the print job to the printer driver in the terminal client, and does not have a unique interface. Since the common interface of the printer driver in the terminal server is expandable, the close cooperative operation between the application and the printer driver which has been performed by the unique interface becomes possible by expanding the common interface of the printer driver in the terminal server.

However, it is not possible for the application to cause the expanded common interface to make setting or acquire information which has been performed by the unique interface. Accordingly, it is not possible to use the unique interface of the printer driver connected to the printer from the application. For this reason, the close cooperative operation between the application and the printer driver which has been realized by the conventional printing system including the terminal server and the terminal client is difficult to perform in the new printing system.

In addition to the above-described case, the application similarly can not function as required, when the application has become unable to use the interface it has been using, for example, due to the following reasons 1 through 3.
1) The printer driver cannot be directly accessed from the application for system configuration reasons.
2) A unique interface cannot be generated for configuration reasons of the printer driver.
3) The unique interface of the printer driver is changed to a different interface.

### SUMMARY OF THE INVENTION

An object of the present invention is directed to a method for replacing a print setting in a unique interface which is generated by the server with a print setting in a common interface by a printer driver in a client.

According to an aspect of the present invention, a printing system includes a server configured to store an application and a client configured to store a printer driver. The server includes an embedding unit configured to embed a print setting of a unique interface in a print setting file, a sending unit configured to send the print setting file in which the print setting of the unique interface is embedded by the embedding unit, to the printer driver, and a receiving unit configured to receive a print setting file in which the print setting of the unique interface is replaced with a print setting of the common interface by the client. The client includes a determining unit configured to determine, by verifying the print setting file sent by the sending unit, whether the print setting of the unique interface is included in the print setting file, a replacing unit configured to replace the print setting of the unique interface with the print setting of the common interface if the determining unit determines that the print setting of the unique interface is included in the print setting file, and a returning unit configured to return the print setting file which includes the print setting of the common interface that is replaced with the replacing unit to the application.

Further features and aspects of the present invention will become apparent from the following detailed description of exemplary embodiments with reference to the attached drawings.

### BRIEF DESCRIPTION OF THE DRAWINGS

The accompanying drawings, which are incorporated in and constitute a part of the specification, illustrate exemplary embodiments, features, and aspects of the invention and, together with the description, serve to explain the principles of the invention.

FIG. 1 is a block diagram illustrating a configuration of a printing system according to an exemplary embodiment of the present invention.

FIG. 2 is a block diagram illustrating a configuration of another printing system according to the exemplary embodiment of the present invention.

FIG. 3 is a block diagram illustrating flow of print data in the printing system including a terminal server and a terminal client illustrated in FIG. 2.

FIG. 4 is a block diagram illustrating a module configuration of a common printing system.

FIGS. 5A and 5B illustrate examples of print setting files of the printing system illustrated in FIG. 2.

FIG. 6 is a block diagram illustrating a module configuration of the printing system according to the exemplary embodiment of the present invention.

FIG. 7 is a block diagram illustrating another module configuration of the printing system according to the exemplary embodiment of the present invention.

FIG. 8 is a flowchart illustrating an example of data processing procedure of an information processing apparatus according to the exemplary embodiment of the present invention.

FIG. 9 is a flowchart illustrating an example of data processing procedure of the information processing apparatus according to the exemplary embodiment of the present invention.

FIG. 10 is a flowchart illustrating an example of data processing procedure of the information processing apparatus according to the exemplary embodiment of the present invention.

FIG. 11 is a block diagram illustrating a module configuration of the printing system according to the exemplary embodiment of the present invention.

FIGS. 12A and 12B illustrate examples of print setting files of the printing system illustrated in FIG. 11.

FIG. 13 illustrates a memory map of a storage medium which stores various data processing programs which can be read by the information processing apparatus according to the exemplary embodiment of the present invention.

### DETAILED DESCRIPTION OF THE EMBODIMENTS

Various exemplary embodiments, features, and aspects of the invention will be described in detail below with reference to the drawings.

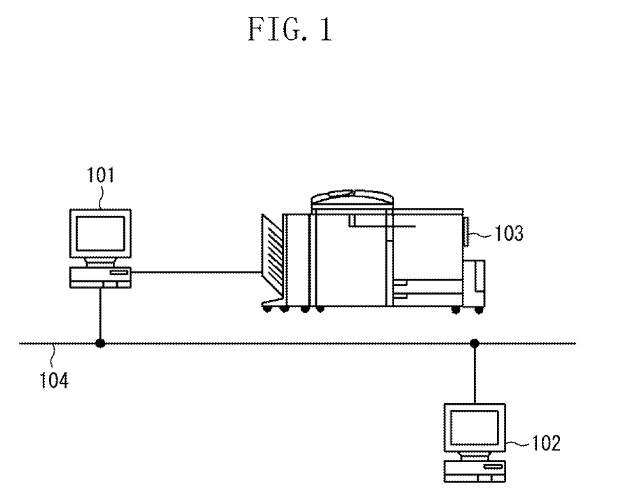

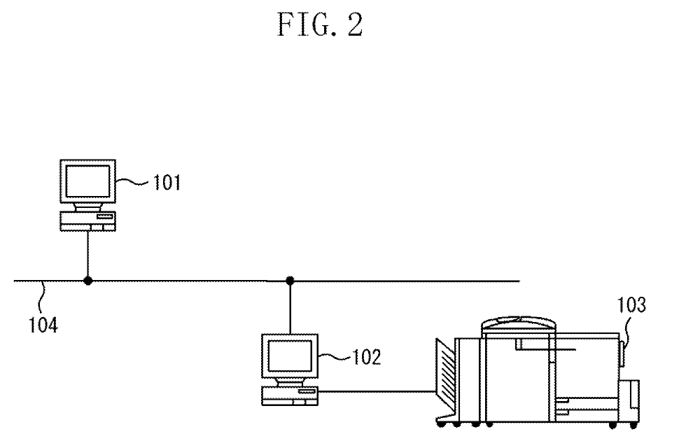

FIGS. 1 and 2 are block diagrams illustrating a configuration of a printing system according to a first exemplary embodiment of the present invention. The printing system includes a terminal server, a terminal client, and a printer.

In FIG. 1, the printing system includes a terminal server 101 and a printer 103 which is connected to the terminal server 101. Although one terminal client 102 is connected to the terminal server 101 in FIG. 1, a plurality of terminal clients can be connected to the terminal server.

The terminal server 101 and the terminal client 102 are connected via a communication medium 104. According to the printing system having such configuration, a user connects to the terminal server 101 via the terminal client 102, and uses an application and a printer driver installed in the terminal server 101 to perform printing. More specifically, the user performs printing operation as described below.

First, the user operates a keyboard or a pointing device connected to the terminal client 102, selects printing from an application menu, and gives a printing instruction to the printer driver using the application installed in the terminal server 101. Based on the printing instruction, the application sends print data to the printer driver. The printer driver converts the received print data into a print code which can be interpreted by the printer 103 and sends the print code to the printer 103. The printer 103 renders the received print code via a work memory and outputs the rendered print data using a printer engine.

The printing system in FIG. 2 is similar to the printing system in FIG. 1 as both systems include the terminal server 101 and terminal client 102. However, the printing system in FIG. 2 is different from the printing system in FIG. 1 in that the printer 103 is connected to the terminal client 102 instead of the server 101 and that the printer driver is installed in the terminal client 102. More specifically, the user performs printing operation as described below.

First, the user operates a keyboard or a pointing device connected to the terminal client 102, selects printing from an application menu, and gives a printing instruction to the printer driver using the application installed in the terminal server 101. Based on the printing instruction, the application sends print data to the terminal client 102 via a system of the terminal server 101.

The printer driver installed in the terminal client 102 converts the received print data into a print code which can be interpreted by the printer 103 and sends the print code to the printer 103. The printer 103 renders the received print code via a work memory and outputs the rendered print data using a printer engine.

In this way, printing is performed in each printing system that includes the terminal server 101 and the terminal client 102 illustrated in FIGS. 1 and 2.

Now, the printing system including the terminal server 101 and the terminal client 102 illustrated in FIG. 2 according to the present exemplary embodiment will be described in detail.

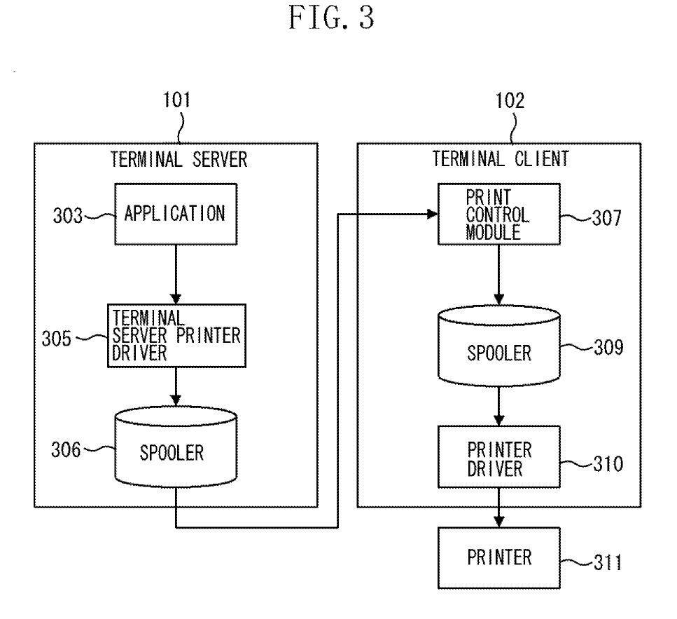

FIG. 3 is a block diagram illustrating a flow of print data in the printing system including the terminal server 101 and the terminal client 102 illustrated in FIG. 2. Print data sent from the terminal server 101 to the terminal client 102 in this printing system has a common format. The common format according to the present exemplary embodiment is Microsoft XPS (XML Paper Specification) which is a platform-independent document format.

The terminal server 101 includes an application 303 which is used by the terminal client 102. The application 303 is used for generating print data in the common format. The print data in the common format is sent to a terminal server printer driver 305 installed in the terminal server 101. Then the print data is sent to the terminal client 102 via a spooler 306.

The terminal client 102 includes a print control module 307 which receives the print data in the common format sent from the terminal server 101. A printer driver 310 installed in the terminal client 102 receives the print data in the common format from the print control module 307 via a spooler 309, converts the print data in the common format into print data which is interpretable by a printer 311, and sends the print data to the printer 311.

If the printer 311 is capable of directly rendering the print data in the common format and printing the data, the printer driver 310 sends the received print data in the common format to the printer 311 without converting the data.

As described above, the user can print a document from the terminal client 102 by using the application installed in the terminal server 101.

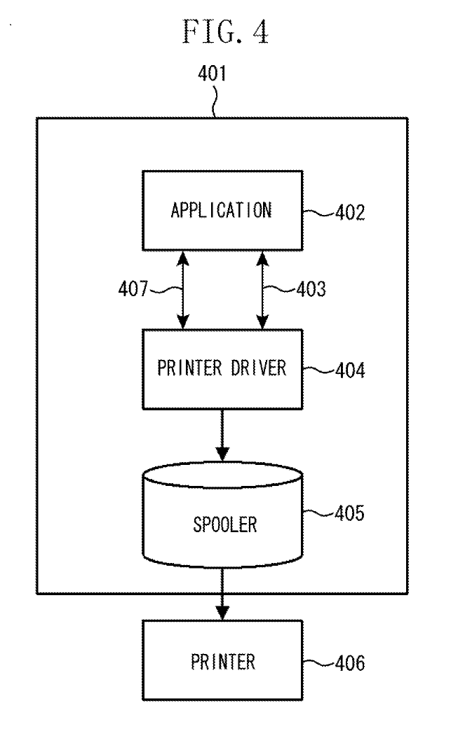

In a common printing system in which an application and a printer driver are installed in a single computer, close cooperative operation between the application and the printer driver using a unique interface is configured as illustrated in FIG. 4.

FIG. 4 is a block diagram illustrating a module configuration of the common printing system. In FIG. 4, a computer 401 includes an application 402, a printer driver 404, and a spooler 405. An operating system (OS) of the computer 401 is not illustrated in FIG. 4.

In performing ordinary printing, the application 402 obtains information from the printer driver 404 and sends print data to the printer driver 404 via a common interface 403.

The printer driver 404 sends the print data to a printer 406 via the spooler 405. Further, the application 402 uses a unique interface 407 to obtain information about staple setting and detailed information on the printer 406 which cannot be obtained from the common interface 403.

According to the printing system illustrated in FIG. 1, since both the application and the printer driver which is connected to the printer 103 are installed in the terminal server 101, the configuration is similar to that illustrated in FIG. 4. Thus, the close cooperative operation between the application and the printer driver using the unique interface is possible.

On the other hand, according to a step printing system illustrated in FIG. 2, the close cooperative operation between the application and the printer driver using a unique interface is not possible, which is described below.

In recent years, a printer driver implements a function for validation process. In the validation process, contents of a print setting file sent from, for example, an application to a printer driver is validated and revised into a print setting file which can be processed by the printer driver. The validation process is broadly classified into “format validation”, “description validation”, and “setting value validation”.

The “format validation” is used for verifying whether a document format of the print setting file can be processed by the printer driver. For example, according to the present exemplary embodiment, since the XPS is used as the common format, the printer driver verifies whether the print setting file is written in an extensible mark-up language (XML). If the printer driver does not determine that the document format of the print setting file can be processed, the printer driver notifies the application to that effect.

On the other hand, if the printer driver determines that the document is in a processable format, then the printer driver executes the “description validation”. The “description validation” is used for verifying whether the printer driver can interpret the description in the print setting file. If the printer driver determines that the description cannot be interpreted, then the printer driver deletes the description and verifies the next description. When verification of all the setting is completed, the printer driver proceeds to the “setting value validation”.

The “setting value validation” is used for verifying whether the print setting described in the print setting file does not conflict with the print setting of the printer driver. If the printer driver determines that the print settings conflict with each other, the printer driver resolves the conflict following a conflict resolution rule of the printer driver. For example, if a staple setting and a print paper size setting are established in the printer driver but a print paper size which cannot be stapled is set in the print setting file, the printer driver determines that the two settings conflict. Further, if the conflict resolution rule is defined so that the staple setting will not be set when the staple setting conflicts with the print paper size setting, the printer driver rewrites the print setting file so that the stapling setting will not be set.

When the above-described validation is completed, the printer driver sends the print setting file to the application as a validated print setting file, and the validation process is completed.

The following describes a problem that occurs when the close cooperative operation between the application and the printer driver in the printing system illustrated in FIG. 2 is performed, and a method for realizing the close cooperation operation. In the printing system illustrated in FIG. 2, since the application is installed in the terminal server 101 and the printer driver is installed in the terminal client 102 which is connected to the printer 103, the configuration of the printing system is different from that illustrated in FIG. 4.

The application of the printing system in FIG. 2 can only access the printer driver for the terminal server installed in the terminal server 101 and unable to access the printer driver installed in the terminal client 102 which is connected to the printer 103. Thus, the application in the terminal server 101 is unable to use the unique interface of the printer driver.

Further, although the printer driver in the terminal client 102 is capable of expanding the common interface, the application in the terminal server 101 cannot make setting or acquire information which has been performed using the unique interface with the expanded common interface. Consequently, the application in the terminal server 101 cannot realize the close cooperative operation with the printer driver in the terminal client 102 using the conventional method.

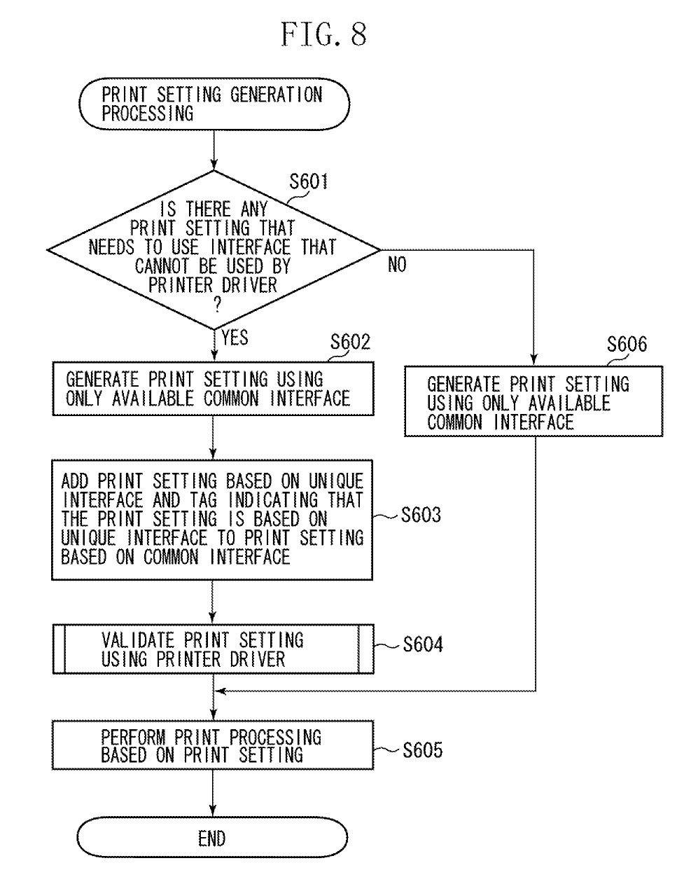

A method for realizing the close cooperative operation between the application and the printer driver according to the present exemplary embodiment will be described referring to FIG. 3. If the application 303 illustrated in FIG. 3 includes a print setting which is set by a unique interface which cannot be used by the printer driver that can be accessed by the application 303, an embedding process for embedding description of the unique interface in the format of the common interface will be added to the printing process. According to the embedding process, not only the description of the unique interface but also a tag indicating that the embedded description is based on the unique interface are embedded in the format of the common interface. Further, the validation process of the print setting format for the terminal server printer driver 305 is added to the application 303 using the common interface (see FIG. 8).

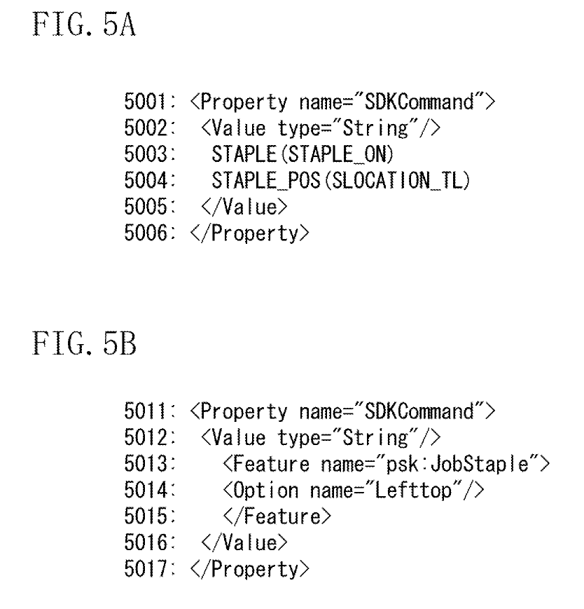

FIGS. 5A and 5B illustrate examples of the print setting files of the printing system illustrated in FIG. 2. The examples in FIGS. 5A and 5B illustrate the print setting files when the description of the unique interface is embedded in the print setting format which can be used by the common interface, and the print setting files after the embedded description is replaced. FIG. 5A is an example before the replacement. FIG. 5B is an example after the replacement.

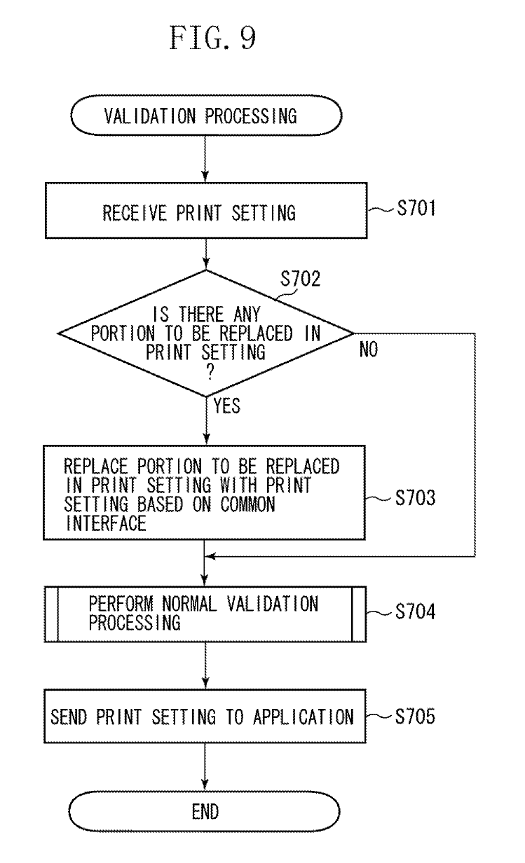

FIG. 5A illustrates that the description of the unique interface is embedded in the format of the common interface. In addition to the embedding process, a process for causing the terminal server printer driver 305 to perform printing using the print setting replaced by the validation process and the common interface, is added to the application 303. If the tag indicating that the description is based on the unique interface is included in the print setting format of a validation target, the printer driver 310 adds a process for replacing the description with a description that can be used by the common interface, to the validation process (see FIG. 9).

FIG. 5B illustrates that the description based on the unique interface is replaced with the description based on the common interface.

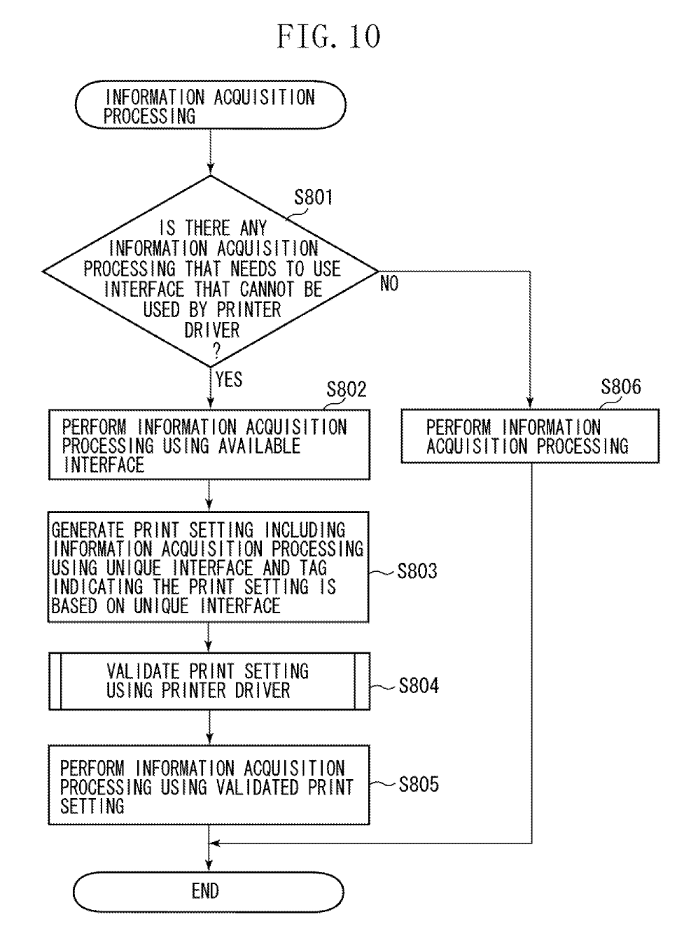

By adding the above-described processes, an operation which is similar to the close cooperative operation which has been performed using the unique interface becomes possible. Further, by embedding an information acquisition instruction of the unique interface in the print setting format which is to be validated, information acquisition process using the common interface (see FIG. 10) becomes possible as well as the print setting.

In FIG. 5A, tags 5001 and 5006 indicate that descriptions between the tags 5001 and 5006 are replacement targets. Tags 5002 and 5005 indicate that descriptions between the tags 5002 and 5005 are character strings. A command 5003 is for performing the staple setting based on the unique interface. A command 5004 indicates a stapling position based on the unique interface.

In FIG. 5B, tags 5011 and 5017 indicate that descriptions between the tags 5011 and 5017 have been replaced. Tags 5012 and 5016 indicate that descriptions between the tags 5012 and 5016 are character strings. Tags 5013 and 5015 indicate a command for performing the staple setting based on the common interface. A tag 5014 is a command for indicating the stapling position based on the common interface.

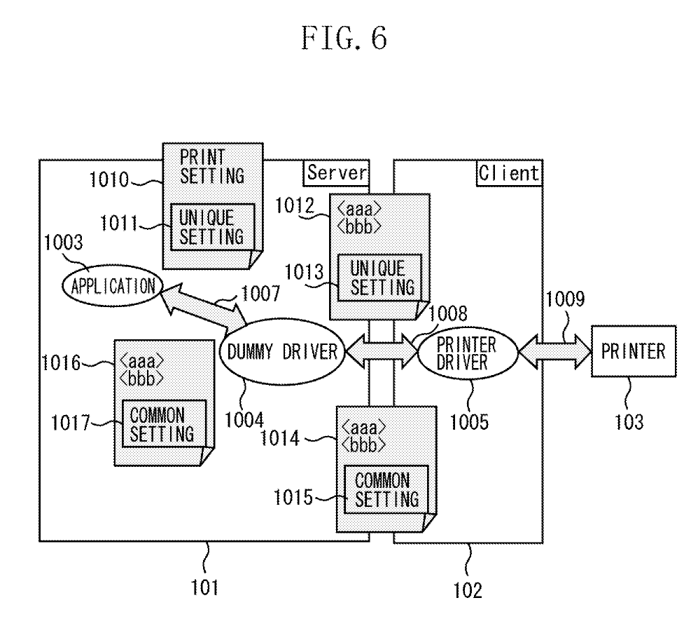

FIG. 6 is a block diagram illustrating a module configuration of the printing system according to the present exemplary embodiment. The printing process will be described below in detail referring to FIG. 6.

In FIG. 6, an application 1003 and a dummy driver 1004 are installed in the terminal server 101. The application 1003 and the dummy driver 1004 are stored in a non-volatile memory, for example a hard disk, which is included in the terminal server 101. A central processing unit (CPU) of the terminal server 101 loads the above-described application 1003 and the dummy driver 1004 into a RAM and executes processing.

The dummy driver 1004 is configured such that it can give a printing instruction to a printer driver 1005 in the terminal client 102 and cause the printer driver 1005 to perform information acquisition process via a common interface 1008. The printer driver 1005 which is installed in the terminal client 102 is capable of giving a printing instruction to the printer 103 and acquires information from the printer 103 via an interface 1009.

When the application 1003 performs printing using the printer 103, the application 1003 uses the printer driver 1005 via the dummy driver 1004. However, since an interface 107 between the application 1003 and the dummy driver 1004 is a common interface, the application 1003 cannot use the unique interface which can be used between the printer driver 1005. Thus, the application 1003 embeds a unique print setting 1011 of the unique interface in a format which can be used by the common interface 1007 with the dummy driver 1004 and generates a print setting file 1010 including the unique print setting 1011.

Next, the application 1003 sends a validation instruction and the print setting file 1010 to the dummy driver 1004. On receiving the validation instruction from the application 1003, the dummy driver 1004 sends the print setting file 1010 to the printer driver 1005 in the terminal client 102 together with the validation instruction. When the printer driver 1005 in the terminal client 102 receives the validation instruction and the print setting file 1012 from the dummy driver 1004, the printer driver 1005 starts the validation process illustrated in FIG. 9.

According to the validation process performed by the printer driver 1005, a print setting file 1014 including a common setting 1015 is generated. The common setting 1015 is a replacement of a unique setting 1013 embedded in the print setting file 1012. Then, the printer driver 1005 returns the generated print setting file 1014 to the dummy driver 1004 in the terminal server 101 together with a validation process completion notification. When the dummy driver 1004 in the terminal server 101 receives the validation process completion notification from the printer driver 1005 in the terminal client 102, the dummy driver 1004 sends a print setting file 1016 to the application 1003 via the common interface 1007.

When the above-described validation process completion notification is received, the application 1003 instructs the dummy driver 1004 to give a printing instruction to the printer driver 1005 using the validated print setting file 1016. At that time, the print setting file 1016 whose validation is completed is sent together with the print data to the dummy driver 1004. When the printing instruction from the application 1003 is received, the dummy driver 1004 sends a printing instruction based on a common setting 1017 as well as the received print data and the print setting file 1016 to the printer driver 1005. When the printer driver 1005 receives the printing instruction based on the common setting 1017 from the dummy driver 1004, the printer driver 1005 causes the printer 103 to perform printing using the received print data and the print setting file 1016.

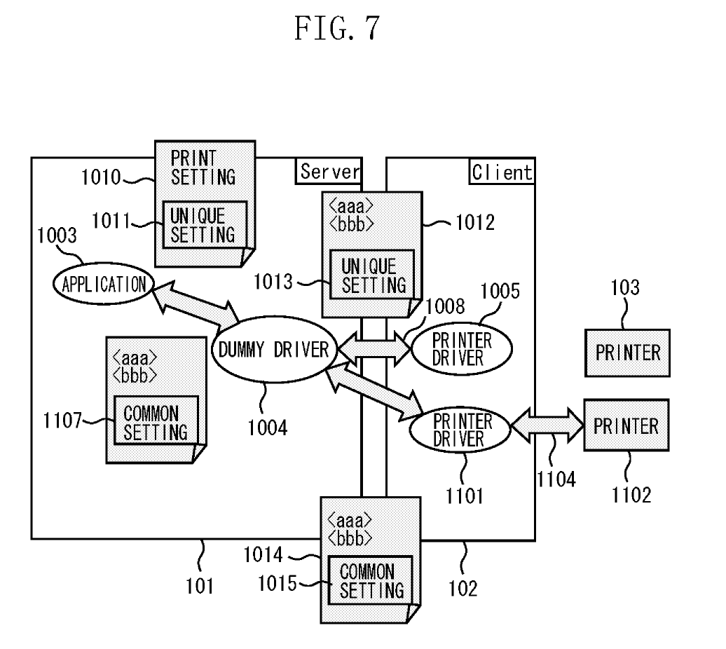

Next, a case where a printing process is performed with respect to the printer driver which cannot replace the description of the unique interface described in the print setting file by the validation process will be described referring to FIG. 7. FIG. 7 is a block diagram illustrating another module configuration of the printing system according to the present exemplary embodiment. The printing process in the printing system will be described in detail referring to FIG. 7. The module configuration in FIG. 7 is different from the module configuration in FIG. 6 in that a printer driver 1101 and a printer 1102 are added to the printing system.

In FIG. 7, the printer driver 1101 does not have a unique interface. Unlike the printer driver 1005 illustrated in FIG. 6, the printer driver 1101 cannot replace the description of the unique interface in the print setting file by the validation process. Thus, according to the configuration illustrated in FIG. 7, the close cooperative operation for the printer 1102 cannot be realized by a similar method described referring to FIG. 6.

According to the configuration illustrated in FIG. 7, first, the validation process is performed by the printer driver 1005 and then the print setting file 1010 including the description of the unique interface is replaced with a print setting file 1107 and stored. When the printing operation is performed, an instruction is given to the dummy driver 1004 to send a printing instruction to the printer driver 1101 using the stored print setting file 1107. When the printer driver 1101 in the terminal client 102 receives the printing instruction from the dummy driver 1004, the printer driver 1101 causes the printer 1102 to perform printing using the received print data and the print setting file 1107 via an interface 1104.

FIG. 8 is a flowchart illustrating an example of data processing procedure of the information processing apparatus according to the present exemplary embodiment. The example illustrated in FIG. 8 is a process in which the application uses the common interface to generate print setting of the unique interface. Each step in the flowchart is realized when the CPU of the terminal server 101 executes the dummy driver 1004 loaded into the RAM.

In step S601, the CPU of the terminal server 101 determines whether an interface that cannot be used by the printer driver 1005 which is directly accessed by the application 1003 needs to be used in the print setting set by the application 1003. The CPU makes this determination by executing the dummy driver 1004 and referring to a table which is stored in a storage device included in the terminal server 101. More specifically, print setting items that need to use the unique interface are included in the table, and the CPU of the terminal server 101 determines whether the print setting set by the application 1003 is included in the table by executing the dummy driver 1004. If the CPU of the terminal server 101 determines that the print setting set by the application 1003 is included in the table, the CPU determines that the interface that cannot be used by the printer driver 1005 needs to be used. If the CPU determines that the interface that cannot be used by the printer driver 1005 needs to be used (YES in step S601), then the process proceeds to step S602. On the other hand, if the CPU determines that only an interface that can be used by the printer driver 1005 needs to be used (NO in step S601), then the process proceeds to step S606.

In step S602, the dummy driver 1004 generates a print setting that does not need to use the unique interface. Then, in step S603, the dummy driver 1004 adds a tag indicating that the description is based on the unique interface, and a description of the print setting which is performed by the unique interface to the print setting generated in step S602. Next, in step S604, the dummy driver 1004 sends the print setting generated in step S603 to the printer driver 1005 for validation. Then, in step S605, the dummy driver 1004 performs the printing process using the print setting validated in step S604, and then the process ends.

On the other hand, in step S606, the dummy driver 1004 generates the print setting using only the description based on the common interface since it does not need to use the unique interface, and then the process proceeds to step S605.

FIG. 9 is a flowchart illustrating an example of data processing procedure of the information processing apparatus according to the present exemplary embodiment. FIG. 9 illustrates an example of the validation process in which the description of the unique interface included in the print setting which is executed by the printer driver 1005 in the terminal client 102 in FIG. 6 is replaced with the description of the common interface. Each step in the flowchart is realized when the CPU of the terminal client 102 executes the printer driver 1005 loaded into the RAM.

In step S701, the printer driver 1005 receives the print setting from the application 1003 via the common interface 1008. Then, in step S702, the CPU of the terminal client 102 examines the printer driver 1005 and determines whether a portion which needs to be replaced is included in the print setting. If the CPU of the terminal client 102 determines that the portion which needs to be replaced is included in the print setting (YES in step S702), then the process proceeds to step S703. If the CPU of the terminal client 102 determines that the portion which needs to be replaced is not included in the print setting (NO in step S702), then the process proceeds to step S704.

In step S703, the printer driver 1005 replaces the description of the unique interface which is described in the replacement target portion in the print setting with the description of the common interface. Next, in step S704, the printer driver 1005 performs the normal validation process and verifies the description in the print setting.

In step S705, the printer driver 1005 sends the print setting to the application 1003 via the common interface 1008, and then the process ends.

FIG. 10 is a flowchart illustrating an example of data processing procedure of the information processing apparatus according to the present exemplary embodiment. The example illustrated in FIG. 10 is a process in which the application uses the common interface to perform information acquisition process of the unique interface. Each step in the flowchart is realized when the CPU of the terminal server 101 executes the application 1003 loaded into the RAM.

In step S801, the CPU of the terminal server 101 determines whether an interface that cannot be used by the printer driver 1005 which is directly accessed by the application 1003 needs to be used in the information acquisition process performed by the application 1003. If the CPU of the terminal server 101 determines that the interface that cannot be used by the printer driver 1005 which is directly accessed by the application 1003 needs to be used (YES in step S801), then the process proceeds to step S802.

On the other hand, if the CPU of the terminal server 101 determines that only an interface that can be used by the printer driver 1005 which is directly accessed by the application 1003 needs to be used (NO in step S801), then the process proceeds to step S806.

In step S802, the application 1003 executes the information acquisition process by an available interface which does not need to use the unique interface. Then, in step S803, the application 1003 generates a print setting including a tag indicating that the description is based on the unique interface and a description of the information acquisition process that is performed by the unique interface.

Next, in step S804, the application 1003 sends the print setting generated in step S803 to the printer driver 1005 for validation via the dummy driver 1004. In step S805, the application 1003 performs the information acquisition process using the print setting validated in step S804 or, more specifically, a replaced command in the validated print setting, and then the process ends.

On the other hand, in step S806, the application 1003 performs the information acquisition process using the common interface 1008 as it does not need to use the unique interface, and then the process ends.

As described above, even if an application cannot directly access a printer driver due to system configuration, a close cooperative operation between the application and the printer driver can be realized similar to a case where the unique interface can be used. Further, even if the unique interface cannot be used, for example, due to the printer driver, the close cooperative cooperation can be realized similar to a case where the unique interface can be used.

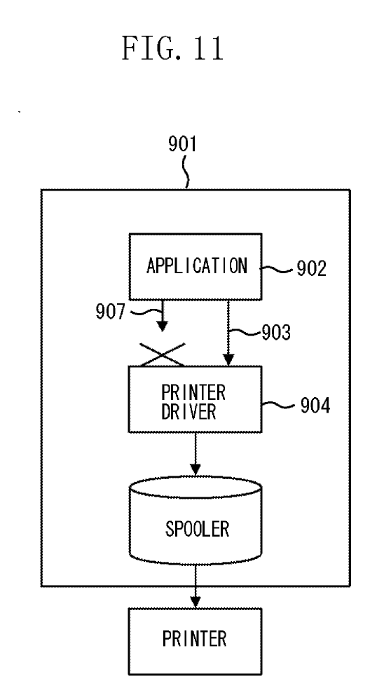

FIG. 11 is a block diagram illustrating a module configuration of a printing system according to a second exemplary embodiment of the present invention. According to the present exemplary embodiment, although an application 902 and a printer driver 904 are installed in a computer 901, only a common interface 903 can be used for reasons different from the first exemplary embodiment.

The reasons why a unique interface 907 cannot be used are as follows:
Reason (1) The printer driver does not have a unique interface.
Reason (2) The printer driver has changed the unique interface to another unique interface.
   A method for using the close cooperation operation between the application 902 and the printer driver 904 in the printing system with the above-described configuration will be described referring to FIG. 11.

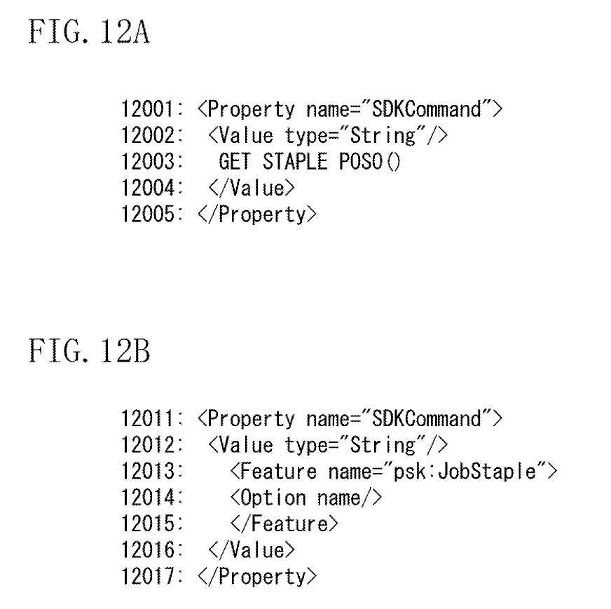

If the application 902 illustrated in FIG. 11 needs to set a print setting by the unique interface that cannot be used by the printer driver 904 which can be accessed by the application 902, an embedding process for embedding description of the unique interface in the format of the common interface 903 will be added to the printing process. According to the embedding process, not only the description of the unique interface 907 but also a tag indicating that the embedded description is based on the unique interface are embedded in the format of the common interface 903 (see FIGS. 12A and 12B). Further, the validation process of the print setting format for the printer driver 904 is added to the application 902 using the common interface 903 (see FIG. 8). More precisely, as illustrated in FIG. 12A, the description of the unique interface is embedded in the format of the common interface. Further, a process for causing the printer driver 904 to perform printing using the print setting which has been replaced by the validation process and the common interface 903 will be added to the application 902. With regard to the printer driver 904, if the tag indicating that the description is based on the unique interface is included in the print setting format of a validation target, a process for replacing the description with a description that can be used by the common interface is added to the validation process (see FIG. 9). FIG. 12B illustrates an example of the description based on the unique interface replaced with the description based on the common interface.

By adding the above-described processes, the close cooperative operation similar to that which has been performed using the unique interface can be performed. Further, by embedding the information acquisition instruction of the unique interface in the print setting format which is to be validated, information acquisition process using the common interface becomes possible similar to the print setting. The information acquired by the process includes a setting value or a setting item of the current printer driver.

FIGS. 12A and 12B illustrate examples of print setting files of the printing system illustrated in FIG. 11. The examples in FIGS. 12A and 12B illustrate the print setting files when the description of the unique interface for the information acquisition is embedded in the print setting format which can be used by the common interface, and the print setting files after the embedded description is replaced. FIG. 12A is an example before the replacement. FIG. 12B is an example after the replacement.

In FIG. 12A, tags 12001 and 12005 indicate that descriptions between the tags 12001 and 12005 are replacement targets. Tags 12002 and 12004 indicate that descriptions between the tags 12002 and 12004 are character strings. A command 12003 is for acquiring a current stapling position based on the unique interface.

In FIG. 12B, tags 12011 and 12017 indicate that descriptions between the tags 12011 and 12017 have been replaced. Tags 12012 and 12016 indicate that descriptions between the tags 12012 and 12016 are character strings. A tag 12013 is for a command for acquiring the current stapling position.

According to the present exemplary embodiment, since the print setting acquired by the application is stored in the storage device of the terminal server, printer-specific print setting and information acquisition can be performed without performing special operation if the printer driver supports the interface that includes the converted print setting.

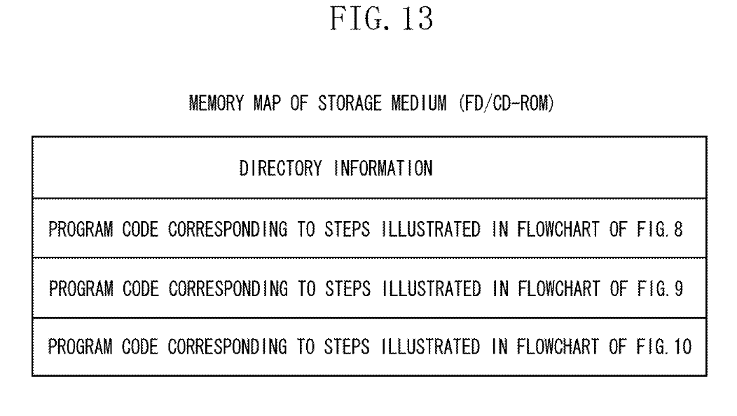

FIG. 13 is a memory map of a storage medium configured to store various types of data processing programs which can be read out by the information processing apparatus according to the exemplary embodiments. Although not illustrated in the drawing, information for managing a program group stored in the storage medium, for example, version information and author information is stored in the storage medium. Further, information which relies on the OS on a program readout side, for example, an icon or the like for identifying a program, can also be stored in the storage medium. Data which is dependent on various types of programs is managed in the directory. Further, a program for installing various programs in a computer and a decompression program which is used when a program to be installed is compressed can also be stored in the storage medium.

Functions illustrated in FIGS. 8, 9, and 10 according to the exemplary embodiments can be realized by a host computer using a program installed from an outside device. In this case, the present invention can be applied when an information group including a program is provided to an output device from the storage medium such as a compact disc read-only memory (CD-ROM), a flash memory, a floppy disk, or an outside storage medium via a network.

As described above, the storage medium storing a software program code which realizes a function of the above-described embodiments is supplied to the printing system or the information processing apparatus. Thus, the present invention can be achieved when a computer (or a CPU or a micro processing unit (MPU)) of the printing system or the information processing apparatus reads and executes the program code stored in the storage medium.

In this case, the program code itself read out from the storage medium realizes the novel functions of the present invention and the storage medium which stores the program code constitutes the present invention.

Thus, the computer-executable program can be provided in a form of an object code, a program executed by an interpreter, or script data supplied to an OS, etc., if it functions as a program.

The storage medium for supplying the program includes, for example, a floppy disk, a hard disk, an optical disk, a magneto-optical disc (MO), a CD-ROM, a CD recordable (CD-R), a CD rewritable (CD-RW), a magnetic tape, a non-volatile memory card, a ROM, and a digital versatile disc (DVD).

In this case, the program code read out from the storage medium itself realizes the functions of the above-described exemplary embodiments and the storage medium which stores the program code constitutes the present invention.

The program can be supplied to a user by connecting to an Internet website using a browser of a client computer and downloading the computer-executable program of the present invention or a compressed file including an automated installation function into the storage medium, such as a hard disk. Further, the program code that configures the program of the exemplary embodiments of the present invention can be divided into a plurality of files and each file can be downloaded from different Internet websites. In other words, a World Wide Web (WWW) server or a file transfer protocol (FTP) server which allows a plurality of users to download the program files to realize the functions of the above-described exemplary embodiments also configures the present invention.

Further, the program according to the exemplary embodiments of the present invention can be encrypted, stored in a storage medium, such as a CD-ROM, and delivered to users. In this case, a user who satisfies a predetermined condition is allowed to download decryption key information from an Internet website via the Internet, to decrypt the encrypted program using the decryption key information, and installs the decrypted program on the computer.

A function of the above-described exemplary embodiments is realized not only when the computer executes the program code. For example, an OS or the like which runs on a computer can execute a part or whole of the actual processing based on an instruction of the program code so that the function of the above-described exemplary embodiments can be achieved.

Furthermore, the program code read out from the storage medium is written in a memory in a function expanding board inserted in a computer or a function expanding unit connected to the computer and a CPU provided in the function expanding board or the function expanding unit performs the whole or a part of the actual processing based on an instruction from the program to realize the functions of the above-described exemplary embodiments.

According to the exemplary embodiments of the present invention, print setting based on a unique interface generated by a server can be replaced with print setting based on a common interface by a printer driver of a client.

While the present invention has been described with reference to exemplary embodiments, it is to be understood that the invention is not limited to the disclosed exemplary embodiments. The scope of the following claims is to be accorded the broadest interpretation so as to encompass all modifications, equivalent structures, and functions.

This application claims priority from Japanese Patent Application No. 2008-024211 filed Feb. 4, 2008, which is hereby incorporated by reference herein in its entirety.

What is claimed is:

1. A printing system comprising a server configured to store an application and a client configured to store a printer driver, wherein the server comprises:
an embedding unit configured to embed a print setting of a unique interface in a print setting file;
a sending unit configured to send the print setting file in which the print setting of the unique interface is embedded by the embedding unit, to the printer driver; and
a receiving unit configured to receive a print setting file in which the print setting of the unique interface is replaced with a print setting in a common interface by the client;
wherein the client comprises:
a determining unit configured to determine, by verifying the print setting file sent by the sending unit, whether the print setting of the unique interface is included in the print setting file;
a replacing unit configured to replace the print setting of the unique interface with the print setting of the common interface if the determining unit determines that the print setting of the unique interface is included in the print setting file; and
a returning unit configured to return the print setting file which includes the print setting of the common interface that is replaced by the replacing unit, to the application.

2. An information processing apparatus configured to send a print setting file to a client which stores a printer driver, the information processing apparatus comprising:
an embedding unit configured to embed a print setting of a unique interface in the print setting file;
a sending unit configured to send the print setting file in which the print setting of the unique interface embedded by the embedding unit, to the printer driver; and
a receiving unit configured to receive a print setting file which is replaced by the client.

3. An information processing apparatus configured to receive a print setting file from a server which stores an application, the information processing apparatus comprising:
a determining unit configured to determine, by verifying the print setting file sent from the server, whether a print setting of a unique interface is included in the print setting file;
a replacing unit configured to replace the print setting in the unique interface with a print setting in a common interface if the determining unit determines that the print setting based of the unique interface is included in the print setting file; and
a returning unit configured to return the print setting file which includes the print setting of the common interface that is replaced by the replacing unit, to the application.

4. A method for controlling a printing system comprising a server configured to store an application and a client configured to store a printer driver, the method comprising a method for controlling the server and a method for controlling the client;
wherein the method for controlling the server comprises:
embedding a print setting of a unique interface in a print setting file;
sending the print setting file in which the print setting of the unique interface is embedded, to the printer driver; and
receiving a print setting file in which the print setting of the unique interface is replaced with a print setting of a common interface by the client;
wherein the method for controlling the client comprises:
verifying the sent print setting file and determining whether the print setting of the unique interface is included in the print setting file;
replacing the print setting of the unique interface with the print setting of the common interface if the print setting of the unique interface is determined to be included in the print setting file; and
returning the print setting file which includes the print setting which is replaced with that of the common interface, to the application.

5. A method for controlling an information processing apparatus configured to send a print setting file to a client which stores a printer driver, the method comprising:
embedding a print setting of a unique interface in the print setting file;
sending the print setting file in which the print setting of the unique interface is embedded, to the printer driver; and
receiving a print setting file replaced by the client.

6. A method for controlling an information processing apparatus configured to receive a print setting file from a server which stores an application, the method comprising:
verifying the print setting file sent from the server and determining whether a print setting of a unique interface is included in the print setting file;
replacing the print setting of the unique interface with a print setting of a common interface if the print setting of the unique interface is determined as included in the print setting file; and
returning the print setting file which includes the print setting which is replaced with that of the common interface, to the application.

7. A computer-readable storage medium which stores instructions executed by an information processing apparatus configured to send a print setting file to a client which stores a printer driver, the instructions comprising:
embedding a print setting of a unique interface in the print setting file;
sending the print setting file in which the print setting of the unique interface is embedded, to the printer driver; and
receiving a print setting file replaced by the client.

8. A computer-readable storage medium which stores instructions executed by an information processing apparatus configured to receive a print setting file from a server which stores an application, the instructions comprising:
verifying the print setting file sent from the server and determining whether a print setting of a unique interface is included in the print setting file;
replacing the print setting of the unique interface with a print setting of a common interface if the print setting of the unique interface is determined to be included in the print setting file; and
returning the print setting file which includes the print setting which is replaced with that of the common interface, to the application.
